(19) United States
(12) Patent Application Publication
(10) Pub. No.: US 2018/0013557 A1
(43) Pub. Date: Jan. 11, 2018

(54) SECRET SHARING SCHEME WITH REQUIRED SHARED KEY(S)

(71) Applicant: Aetna Inc., Hartford, CT (US)

(72) Inventor: Salil Kumar Jain, Jackson Heights, NY (US)

(21) Appl. No.: 15/264,055

(22) Filed: Sep. 13, 2016

Related U.S. Application Data
(60) Provisional application No. 62/360,692, filed on Jul. 11, 2016.

(51) Int. Cl. H04L 9/08; G06F 21/62; H04L 9/14

(52) U.S. Cl. CPC H04L 9/0861; H04L 9/14; G06F 21/6209; H04L 9/085; H04L 2209/24

(57) ABSTRACT

A method for secret sharing with required key(s) includes: generating, by a computing system, a secret key such that a minimum number of a plurality of shared keys, together with one or more required keys, are needed for derivation of the secret key; and encrypting, by the computing system, an element to be protected using the secret key.

### CROSS-REFERENCE TO RELATED APPLICATIONS

This patent application claims the benefit of U.S. Provisional Patent Application No. 62/360,692, filed Jul. 11, 2016, which is incorporated by reference in its entirety.

### BACKGROUND

In a conventional secret sharing scheme, a secret key S based on a total number N of shared keys may be obtained so long as a sufficient number K out of the N shared keys are known. This provides for security, for example, in applications where limited access to certain networks or systems or where data encryption is desired. A user or entity that does not have at least K shared keys out of the N shared keys is unable to obtain the secret key S.

### SUMMARY

In an exemplary embodiment, the invention provides a non-transitory computer-readable medium having processor-executable instructions stored thereon for secret sharing with required key(s), the processor-executable instructions, when executed, facilitating performance of the following: generating a secret key such that a minimum number of a plurality of shared keys, together with one or more required keys, are needed for derivation of the secret key; and encrypting an element to be protected using the secret key.

In another exemplary embodiment, the invention provides a method for secret sharing with required key(s), the method comprising: generating, by a computing system, a secret key such that a minimum number of a plurality of shared keys, together with one or more required keys, are needed for derivation of the secret key; and encrypting, by the computing system, an element to be protected using the secret key.

### BRIEF DESCRIPTION OF DRAWINGS

The present invention will be described in even greater detail below based on the exemplary figures. The invention is not limited to the exemplary embodiments. All features described and/or illustrated herein can be used alone or combined in different combinations in embodiments of the invention. The features and advantages of various embodiments of the present invention will become apparent by reading the following detailed description with reference to the attached drawings which illustrate the following:

FIG. 1 illustrates an exemplary environment in which embodiments of the invention may be implemented.

FIG. 2 is a flowchart illustrating an exemplary process for generating a secret key with one or more required shared keys.

FIG. 3 is a flowchart illustrating an exemplary process for obtaining the secret key generated according to the process shown in FIG. 2.

FIG. 4 is a flowchart illustrating another exemplary process for generating a secret key with one or more required shared keys.

FIG. 5 is a flowchart illustrating an exemplary process for obtaining the secret key generated according to the process shown in FIG. 4.

### DETAILED DESCRIPTION

Embodiments of the invention provide a shared key scheme where a secret key S is divided into N shared keys, and one or more of the N shared keys is/are required shared keys such that even if a user or entity has a sufficient number K out of the N shared keys, the secret key S cannot be obtained unless the user or entity has the required shared key(s).

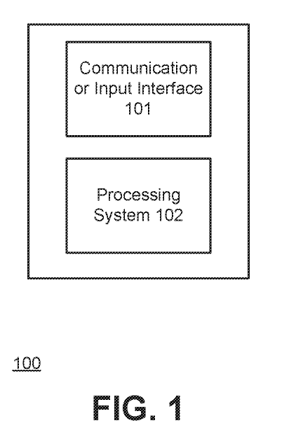

FIG. 1 illustrates an exemplary environment in which embodiments of the invention may be implemented. Device 100 may be a computing device, such as a server, personal computer, mobile device, etc., having a communication or input interface 101 through which a user or another entity provides an input (e.g., providing shared keys including required shared key(s) of a shared secret scheme to the device). The device 100 further includes a processing system 102, which may include one or more processors, for obtaining a secret key S.

For example, if the processing system 102 is provided with at least Kₐᵤₓ auxiliary shared keys out of Nₐᵤₓ auxiliary shared keys for an auxiliary secret Sₐᵤₓ as well as all required shared key(s), the processing system 102 is able to obtain a secret key S. Or, in other words, if the processing system 102 is provided with at least K shared keys out of N total shared keys corresponding to the secret key S, wherein the K shared keys include all required shared key(s), the processing system 102 is able to obtain the secret key S.

It will be appreciated that another device having similar components as those illustrated in FIG. 1 may be utilized to generate the secret key S (as well as the shared keys and required key(s)), or that device 100 may also be used to generate the secret key S (as well as the shared keys and required key(s)).

It will be appreciated that relevant components are depicted in FIG. 1 for illustration purposes, and that devices used in exemplary embodiments of the invention may further include various other components familiar to those of ordinary skill in the art. It will further be appreciated that the environment depicted in FIG. 1 is merely exemplary, and that embodiments of the invention are not limited thereto. For example, embodiments of the invention may be used in other computing and networking environments utilizing a shared secret scheme. It will further be appreciated that the execution of various machine-implemented processes and steps described herein may occur via the computerized execution of processor-executable instructions stored on a non-transitory computer-readable medium (e.g., RAM, ROM, PROM, volatile, nonvolatile, or other electronic memory mechanism) by one or more corresponding processor(s).

In an exemplary embodiment, a secret key S may be based on a number P of required shared key(s) L and an auxiliary secret key Sₐᵤₓ corresponding to a total number Nₐᵤₓ of auxiliary shared keys, of which at least a sufficient number Kₐᵤₓ of auxiliary shared keys must be known to obtain Sₐᵤₓ. In one example, the secret key S and the required shared key(s) L are randomly generated strings, and Sₐᵤₓ may be derived as follows: Sₐᵤₓ=(S XOR L₁ XOR L₂ . . . XOR L_{P}), which corresponds to performing an XOR operation with respect to S and L₁ through L_{P}. In another example, the secret key S and the required key(s) L₁ through L_{P} are randomly generated large numbers, and Sₐᵤₓ may be derived as follows: Sₐᵤₓ=(S−L₁−L₂− . . . −L_{P}), which corresponds to performing a subtraction operation of L₁ through L_{P} from S. It will be appreciated that these two examples are merely exemplary, and that auxiliary secret key Sₐᵤₓ may be derived from S and L₁ through L_{P} through other relationships as well.

In another exemplary embodiment, an auxiliary secret key Sₐᵤₓ corresponding to a total number Nₐᵤₓ of auxiliary shared keys, of which at least a sufficient number Kₐᵤₓ of auxiliary shared keys must be known to obtain Sₐᵤₓ, is randomly generated, as well as a number P of required shared key(s) L, and the secret key S is derived based on the auxiliary secret key Sₐᵤₓ and the required shared key(s) L.

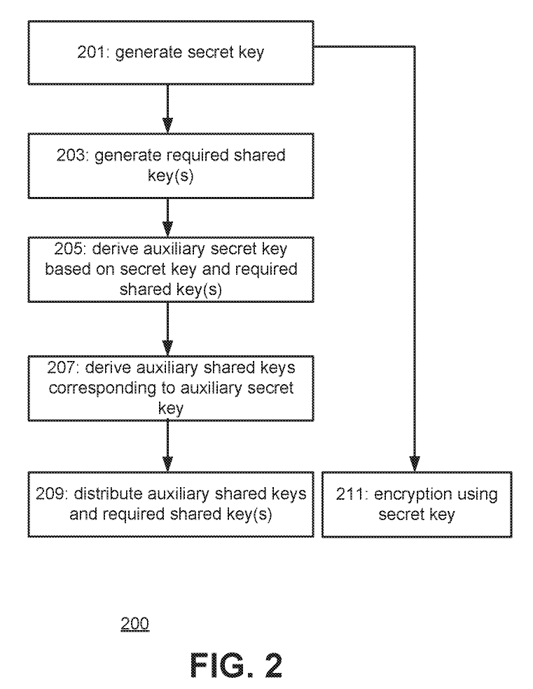

FIG. 2 is a flowchart illustrating an exemplary process 200 for generating a secret key with one or more required shared keys in accordance with this first exemplary embodiment.

At stage 201, secret key S is generated. In an exemplary implementation, secret key S may be a randomly generated string or number.

At stage 203, P number of required shared key(s) L (e.g., L₁ through L_{P}) is/are generated. In an exemplary implementation, the required shared key(s) L may be randomly generated string(s) or number(s) as well.

At stage 205, auxiliary secret key Sₐᵤₓ is derived based on secret key S and required shared key(s) L. As discussed above, in one exemplary implementation, Sₐᵤₓ may be derived through an XOR operation Sₐᵤₓ=(S XOR L₁ XOR L₂ . . . XOR L_{P}), and in another exemplary implementation, Sₐᵤₓ may be derived through a subtraction operation Sₐᵤₓ=(S−L₁−L₂− . . . −L_{P}).

As mentioned above, in another exemplary embodiment (not depicted in FIG. 2), the auxiliary secret key Sₐᵤₓ is randomly generated, as well as the required shared key(s) L, and the secret key S is derived based on the auxiliary secret key Sₐᵤₓ and the required shared key(s) L.

At stage 207, a total number Nₐᵤₓ of auxiliary shared keys are derived based on Sₐᵤₓ, of which at least a sufficient number Kₐᵤₓ of auxiliary shared keys must be known to obtain Sₐᵤₓ. In various exemplary implementations, different schemes for deriving the auxiliary shared keys based on auxiliary secret key Sₐᵤₓ may be used, including, for example, Shamir's scheme, Blakley's scheme, and using the Chinese remainder theorem.

At stage 209, some or all of the Nₐᵤₓ auxiliary shared keys and L (or L₁ through L_{P}) required shared key(s) are distributed. For example, the required shared key(s) may be provided to or distributed among one or more persons or entities (such as one or more computing devices or secure storages), and the auxiliary shared keys may also be distributed among one or more persons or entities. In this way, secret key S is available only when a combination of persons and/or entities are brought together or provide their respective shared keys together such that at least Kₐᵤₓ auxiliary shared keys and all required shared keys are presented to a processing system capable of obtaining the secret key S according to the secret sharing scheme.

At stage 211, data or a token or some other element is encrypted using the secret key. The encrypted element will thus only be able to be decrypted by a computing device that is able to obtain the secret key (e.g., a computing device that is able to obtain at least Kₐᵤₓ auxiliary shared keys to obtain Sₐᵤₓ, as well as all required shared key(s), to obtain the secret key S therefrom, or a computing device that is able to obtain Sₐᵤₓ and all required shared key(s) to obtain the secret key S therefrom).

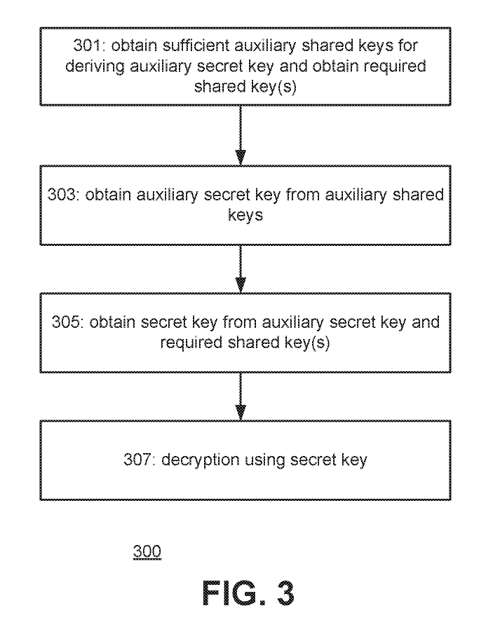

FIG. 3 is a flowchart illustrating an exemplary process 300 for obtaining the secret key generated according to the process shown in FIG. 2.

At stage 301, at least a sufficient number Kₐᵤₓ of auxiliary shared keys for obtaining auxiliary secret key Sₐᵤₓ, as well as all required shared keys L, are obtained by a processing system. For example, a person may gather multiple secure cards having different required and/or auxiliary shared keys stored thereon and provide the keys to a processing system, or multiple persons and/or computing devices each having different respective required and/or auxiliary shared keys may collaboratively provide the keys to a processing system.

At stage 303, auxiliary secret key Sₐᵤₓ is obtained from the Kₐᵤₓ auxiliary shared keys obtained at stage 301. As discussed above with respect to stage 207, different schemes may be used for dividing auxiliary secret key Sₐᵤₓ into Nₐᵤₓ shared keys such that Kₐᵤₓ auxiliary shared keys are sufficient to obtain auxiliary secret key Sₐᵤₓ. At stage 303, the same scheme that was used for generating the Nₐᵤₓ auxiliary shared keys is now used to obtain auxiliary secret key Sₐᵤₓ from the Kₐᵤₓ auxiliary shared keys obtained at stage 301.

At stage 305, secret key S is obtained from auxiliary secret key Sₐᵤₓ obtained at stage 303 and the required shared key(s) L obtained at stage 301. As discussed above with respect to stage 205, secret key S and auxiliary secret key Sₐᵤₓ have a certain relationship. For example, if at stage 205, auxiliary secret key Sₐᵤₓ was derived based on the relation Sₐᵤₓ=(S XOR L₁ XOR L₂ . . . XOR L_{P}), then secret key S may be obtained at stage 305 based on the relation S=(Sₐᵤₓ XOR L₁ XOR L₂ . . . XOR L_{P}). In another example, if at stage 205, auxiliary secret key Sₐᵤₓ was derived based on the relation Sₐᵤₓ=(S−L₁−L₂− . . . −L_{P}), then secret key S may be obtained at stage 305 based on the relation S=(Sₐᵤₓ+L₁+L₂+ . . . +L_{P}).

At stage 307, secret key S may then be used or provided to another entity to be used for decrypting one or more elements that were encrypted using secret key S at stage 211.

In an alternative exemplary embodiment, a secret key S may be decomposed into two secret keys, a first secret key S_{req} comprised of required shared keys and a second secret key Sₐᵤₓ comprised of auxiliary shared keys such that S=S_{req} XOR Sₐᵤₓ, where Sₐᵤₓ corresponds to a total number Nₐᵤₓ of auxiliary shared keys, of which at least a sufficient number Kₐᵤₓ of shared keys must be known to obtain Sₐᵤₓ, and S_{req} corresponds to a total number P of required shared keys, all of which must be known to obtain S_{req}. It will be appreciated that this alternative exemplary embodiment is conceptually similar to the exemplary embodiments discussed above.

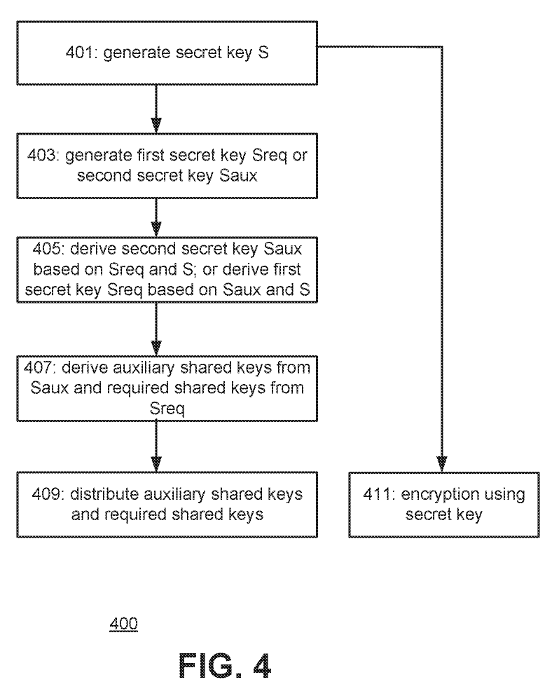

FIG. 4 is a flowchart illustrating an exemplary process 400 for generating a secret key with one or more required shared keys in accordance with this alternative exemplary embodiment. At stage 401, secret key S is generated. In an exemplary implementation, secret key S may be a randomly generated string or number.

At stage 403, the first secret key S_{req} (which is a required shared key or to be divided into multiple required shared keys) or the second secret key Sₐᵤₓ (an “auxiliary shared key” to be divided into multiple auxiliary shared keys) is generated. In an exemplary implementation, the first secret key S_{req} or the second secret key Sₐᵤₓ may be randomly generated string(s) or number(s) as well.

At stage 405, second secret key Sₐᵤₓ is derived based on secret key S and the first secret key S_{req}, or the first secret key S_{req} is derived based on secret key S and the second secret key Sₐᵤₓ. In one exemplary implementation, Sₐᵤₓ may be derived through an XOR operation Sₐᵤₓ=(S XOR S_{req}), and in another exemplary implementation, S_{req} may be derived through an XOR operation S_{req}=(S XOR Sₐᵤₓ).

In an alternative exemplary implementation (not depicted in FIG. 4), both the first secret key S_{req} and the second secret key Sₐᵤₓ may be randomly generated, with secret key S being derived based on the first secret key S_{req} and the second secret key Sₐᵤₓ.

At stage 407, a total number Nₐᵤₓ of auxiliary shared keys are derived based on the second secret key Sₐᵤₓ, of which at least a sufficient number Kₐᵤₓ of auxiliary shared keys must be known to obtain Sₐᵤₓ. In various exemplary implementations, different schemes for deriving the auxiliary shared keys based on auxiliary secret key Sₐᵤₓ may be used, including, for example, Shamir's scheme, Blakley's scheme, and using the Chinese remainder theorem. A total number P of required shared keys may also be derived based on the first secret key S_{req}, all of which are required to obtain S_{req}. In one example, the relationship between the S_{req} and the P required shared keys may be S_{req}=(L₁ XOR L₂ . . . XOR L_{P}), where L₁ through L_{P} are the P required shared keys.

At stage 409, some or all of the auxiliary shared keys and the required shared keys are distributed. For example, the required shared key(s) may be provided to or distributed among one or more persons or entities (such as one or more computing devices or secure storages), and the auxiliary shared keys may also be distributed among one or more persons or entities. In this way, secret key S is available only when a combination of persons and/or entities are brought together or provide their respective shared keys together such that at least Kₐᵤₓ auxiliary shared keys and all required shared keys are presented to a processing system capable of obtaining the secret key S according to the secret sharing scheme.

At stage 411, data or a token or some other element is encrypted using the secret key. The encrypted element will thus only be able to be decrypted by a computing device that is able to obtain the secret key (e.g., a computing device that is able to obtain at least Kₐᵤₓ auxiliary shared keys to obtain Sₐᵤₓ, as well as all required shared key(s), to obtain the secret key S therefrom, or a computing device that is able to obtain Sₐᵤₓ and all required shared key(s) to obtain the secret key S therefrom).

Alternatively (not depicted in FIG. 4), in embodiments where only one required shared key is desired, S_{req} itself may be used as the required shared key.

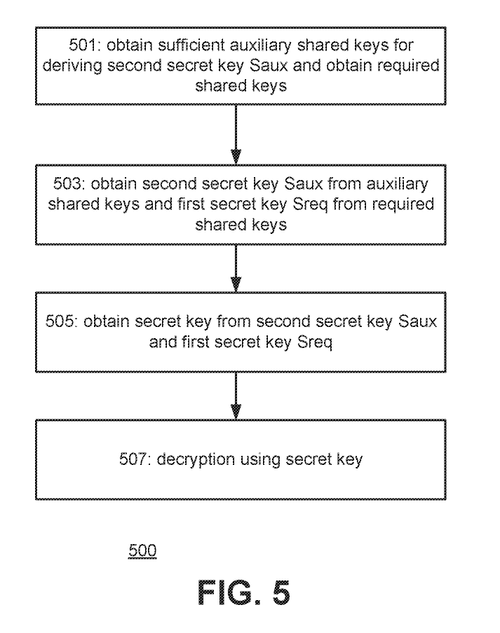

FIG. 5 is a flowchart illustrating an exemplary process 500 for obtaining the secret key generated according to the process shown in FIG. 4.

At stage 501, at least a sufficient number Kₐᵤₓ of auxiliary shared keys for obtaining the second secret key Sₐᵤₓ, as well as all required shared keys for obtaining the first secret key S_{req}, are obtained by a processing system.

At stage 503, the second secret key Sₐᵤₓ is obtained from the Kₐᵤₓ auxiliary shared keys obtained at stage 501, and the first secret key S_{req} is obtained from the P required shared keys (e.g., using the same schemes and/or relationships discussed above with respect to stage 407).

In an alternative embodiment (not depicted in FIG. 5), as discussed above, when there is only one required shared key, the first secret key S_{req} may be the required shared key and may be directly obtained at stage 501 (and does not need to be obtained at stage 503).

At stage 505, secret key S is obtained from second secret key Sₐᵤₓ and the first secret key S_{req} (e.g., according to the relationships discussed above with respect to stage 405 such that S=(S_{req} XOR Sₐᵤₓ)). At stage 507, secret key S may then be used or provided to another entity to be used for decrypting one or more elements that were encrypted using secret key S at stage 411.

It will thus be appreciated that exemplary embodiments of the invention discussed herein provide an advantageous secret sharing scheme in which certain shared keys can be required, providing two tiers of shared keys for a more sophisticated and secure secret sharing system.

All references, including publications, patent applications, and patents, cited herein are hereby incorporated by reference to the same extent as if each reference were individually and specifically indicated to be incorporated by reference and were set forth in its entirety herein.

The use of the terms “a” and “an” and “the” and “at least one” and similar referents in the context of describing the invention (especially in the context of the following claims) are to be construed to cover both the singular and the plural, unless otherwise indicated herein or clearly contradicted by context. The use of the term “at least one” followed by a list of one or more items (for example, “at least one of A and B”) is to be construed to mean one item selected from the listed items (A or B) or any combination of two or more of the listed items (A and B), unless otherwise indicated herein or clearly contradicted by context. The terms “comprising,” “having,” “including,” and “containing” are to be construed as open-ended terms (i.e., meaning “including, but not limited to,”) unless otherwise noted. Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better illuminate the invention and does not pose a limitation on the scope of the invention unless otherwise claimed. No language in the specification should be construed as indicating any non-claimed element as essential to the practice of the invention.

Preferred embodiments of this invention are described herein, including the best mode known to the inventors for carrying out the invention. Variations of those preferred embodiments may become apparent to those of ordinary skill in the art upon reading the foregoing description. The inventors expect skilled artisans to employ such variations as appropriate, and the inventors intend for the invention to be practiced otherwise than as specifically described herein. Accordingly, this invention includes all modifications and equivalents of the subject matter recited in the claims appended hereto as permitted by applicable law. Moreover, any combination of the above-described elements in all possible variations thereof is encompassed by the invention unless otherwise indicated herein or otherwise clearly contradicted by context.

1. A non-transitory computer-readable medium having processor-executable instructions stored thereon for secret sharing with required key(s), the processor-executable instructions, when executed, facilitating performance of the following:
generating a secret key such that a minimum number of a plurality of shared keys, together with one or more required keys, are needed for derivation of the secret key; and
encrypting an element to be protected using the secret key.

2. The non-transitory computer-readable medium according to claim 1, wherein generating the secret key such that a minimum number of a plurality of shared keys, together with one or more required keys, are needed for derivation of the secret key further comprises:
generating the secret key;
generating the one or more required keys;
deriving an auxiliary secret key based on the secret key and the one or more required keys; and
deriving the plurality of shared keys based on the auxiliary secret key based on a secret sharing scheme, wherein the minimum number of the plurality of shared keys is needed for derivation of the auxiliary secret key.

3. The non-transitory computer-readable medium according to claim 1, wherein generating the secret key such that a minimum number of a plurality of shared keys, together with one or more required keys, are needed for derivation of the secret key further comprises:
generating an auxiliary secret key;
generating the one or more required keys;
deriving the secret key based on the auxiliary secret key and the one or more required keys; and
deriving the plurality of shared keys based on the auxiliary secret key based on a secret sharing scheme, wherein the minimum number of the plurality of shared keys is needed for derivation of the auxiliary secret key.

4. The non-transitory computer-readable medium according to claim 1, wherein generating the secret key such that a minimum number of a plurality of shared keys, together with one or more required keys, are needed for derivation of the secret key further comprises:
generating the secret key;
generating a first additional secret key;
deriving a second additional secret key based on the secret key and the first additional secret key;
deriving the plurality of shared keys based on the first additional secret key based on a secret sharing scheme, wherein the minimum number of the plurality of shared keys is needed for derivation of the first additional secret key; and
obtaining the one or more required keys based on the second additional secret key.

5. The non-transitory computer-readable medium according to claim 4, wherein obtaining the one or more required keys based on the second additional secret key further comprises:
using the second additional secret key as a required key.

6. The non-transitory computer-readable medium according to claim 4, wherein obtaining the one or more required keys based on the second additional secret key further comprises:
deriving multiple required keys based on the second additional secret key based on a secret sharing scheme, wherein all of the multiple required keys are needed for derivation of the second additional secret key.

7. The non-transitory computer-readable medium according to claim 1, wherein generating the secret key such that a minimum number of a plurality of shared keys, together with one or more required keys, are needed for derivation of the secret key further comprises:
generating the secret key;
generating a first additional secret key;
deriving a second additional secret key based on the secret key and the first additional secret key;
deriving the plurality of shared keys based on the second additional secret key based on a secret sharing scheme, wherein the minimum number of the plurality of shared keys is needed for derivation of the second additional secret key; and
obtaining the one or more required keys based on the first additional secret key.

8. The non-transitory computer-readable medium according to claim 7, wherein obtaining the one or more required keys based on the first additional secret key further comprises:
using the first additional secret key as a required key.

9. The non-transitory computer-readable medium according to claim 7, wherein obtaining the one or more required keys based on the first additional secret key further comprises:
deriving multiple required keys based on the first additional secret key based on a secret sharing scheme, wherein all of the multiple required keys are needed for derivation of the first additional secret key.

10. The non-transitory computer-readable medium according to claim 1, wherein the processor-executable instructions, when executed, further facilitate:
distributing the plurality of shared keys and the one or more required keys.

11. A method for secret sharing with required key(s), the method comprising:
generating, by a computing system, a secret key such that a minimum number of a plurality of shared keys, together with one or more required keys, are needed for derivation of the secret key; and
encrypting, by the computing system, an element to be protected using the secret key.

12. The method according to claim 11, wherein generating the secret key such that a minimum number of a plurality of shared keys, together with one or more required keys, are needed for derivation of the secret key further comprises:
generating the secret key;
generating the one or more required keys;
deriving an auxiliary secret key based on the secret key and the one or more required keys; and
deriving the plurality of shared keys based on the auxiliary secret key based on a secret sharing scheme, wherein the minimum number of the plurality of shared keys is needed for derivation of the auxiliary secret key.

13. The method according to claim 11, wherein generating the secret key such that a minimum number of a plurality of shared keys, together with one or more required keys, are needed for derivation of the secret key further comprises:
generating an auxiliary secret key;
generating the one or more required keys;
deriving the secret key based on the auxiliary secret key and the one or more required keys; and
deriving the plurality of shared keys based on the auxiliary secret key based on a secret sharing scheme, wherein the minimum number of the plurality of shared keys is needed for derivation of the auxiliary secret key.

14. The method according to claim 11, wherein generating the secret key such that a minimum number of a plurality of shared keys, together with one or more required keys, are needed for derivation of the secret key further comprises:
generating the secret key;
generating a first additional secret key;
deriving a second additional secret key based on the secret key and the first additional secret key;
deriving the plurality of shared keys based on the first additional secret key based on a secret sharing scheme, wherein the minimum number of the plurality of shared keys is needed for derivation of the first additional secret key; and
obtaining the one or more required keys based on the second additional secret key.

15. The method according to claim 14, wherein obtaining the one or more required keys based on the second additional secret key further comprises:
using the second additional secret key as a required key.

16. The method according to claim 14, wherein obtaining the one or more required keys based on the second additional secret key further comprises:
deriving multiple required keys based on the second additional secret key based on a secret sharing scheme, wherein all of the multiple required keys are needed for derivation of the second additional secret key.

17. The method according to claim 11, wherein generating the secret key such that a minimum number of a plurality of shared keys, together with one or more required keys, are needed for derivation of the secret key further comprises:
generating the secret key;
generating a first additional secret key;
deriving a second additional secret key based on the secret key and the first additional secret key;
deriving the plurality of shared keys based on the second additional secret key based on a secret sharing scheme, wherein the minimum number of the plurality of shared keys is needed for derivation of the second additional secret key; and
obtaining the one or more required keys based on the first additional secret key.

18. The method according to claim 17, wherein obtaining the one or more required keys based on the first additional secret key further comprises:
using the first additional secret key as a required key.

19. The method according to claim 17, wherein obtaining the one or more required keys based on the first additional secret key further comprises:
deriving multiple required keys based on the first additional secret key based on a secret sharing scheme, wherein all of the multiple required keys are needed for derivation of the first additional secret key.

20. The method according to claim 11, wherein the method further comprises:
distributing the plurality of shared keys and the one or more required keys.
